(19) United States
(12) Patent Application Publication
(10) Pub. No.: US 2021/0173062 A1
(43) Pub. Date: Jun. 10, 2021

(54) ASSEMBLY FOR A MOTOR VEHICLE WITH AN ULTRASONIC SENSOR AND WITH A DAMPING ELEMENT THAT COMPRISES REINFORCING ELEMENTS AND ALSO A DEVICE

(71) Applicant: Valeo Schalter und Sensoren GmbH, Bietigheim-Bissingen (DE)

(72) Inventors: Uwe Kupfernagel, Bietigheim-Bissingen (DE); Felix Haering, Bietigheim-Bissingen (DE); Marian Roeger, Bietigheim-Bissingen (DE)

(73) Assignee: Valeo Schalter und Sensoren GmbH, Bietigheim-Bissingen (DE)

(21) Appl. No.: 16/763,765

(22) PCT Filed: Oct. 12, 2018
(86) PCT No.: PCT/EP2018/077927

§ 371 Date: May 13, 2020

(30) Foreign Application Priority Data
Nov. 22, 2017 (DE) 10 2017 127 587.8

(51) Int. Cl. G01S 7/521; G01S 15/931; G10K 11/162

(52) U.S. Cl. CPC G01S 7/521; G01S 2015/937; G10K 11/162; G01S 15/931

(57) ABSTRACT

The invention relates to an assembly (5) for a motor vehicle (1) with an ultrasonic sensor (5a) that is designed for concealed installation at a cladding part (15) of the motor vehicle (1), and that comprises a membrane (13) capable of oscillation for transmitting and/or receiving ultrasonic signals (8), wherein ultrasonic signals (8) can be transferred by means of the membrane (13) to the cladding part (15), and with a damping element (17) that is arranged around a longitudinal axis (L) of the membrane (13) and around the ultrasonic sensor (5a), wherein at least the membrane (13) extends through a cutout (31) of the damping element (17), wherein oscillations of the cladding part (15) can be attenuated by means of the damping element (17) when in the installed state, wherein the damping element (17) comprises reinforcing elements (25). The invention further relates to a device with an assembly.

The present invention relates to an assembly with an ultrasonic sensor for a motor vehicle that is designed for concealed installation in a cladding part of the motor vehicle. The ultrasonic sensor comprises a membrane capable of oscillation for transmitting and/or receiving ultrasonic signals. Ultrasonic signals can be transmitted to the cladding part by means of the membrane. The ultrasonic sensor comprises a damping element that is arranged around a longitudinal axis of the membrane, so that oscillations of the cladding part can be attenuated when in the installed state. The invention further relates to a device with an assembly.

In order to enable an improved function of ultrasonic sensors with concealed installation in terms of the oscillation time and decay time, it is necessary that the oscillation energy that is introduced into the surrounding vehicle structure by the ultrasonic sensor is attenuated as effectively as possible over the entire operating temperature range. Very different types of damping materials or damping concepts are already known in this respect. Usual materials include for example bitumen, heavy foils, high-polymer materials or buty rubber. In the case of the materials just mentioned, it has been found that an improved attenuation is associated with a narrower operating range in terms of the temperature and frequency. Butyl rubber for example has a very high damping effect in the ultrasonic range over a wide temperature range. It is, however, disadvantageous here that at temperatures above room temperature (approx. 21° C.) the butyl rubber becomes increasingly soft. The consequence of this is that the oscillation energy cannot penetrate into the full depth of the damping material, but is only effective in the layers that bound the bodywork component.

US 2017/0059697 A1 discloses an ultrasonic sensor assembly with concealed ultrasonic sensor. A coupling element is arranged between the ultrasonic sensor, in particular the membrane, and the interior surface of the cladding part. The coupling element can comprise a matrix material that is reinforced with a filler. The ultrasonic sensor assembly further comprises a damping element that is placed against the interior surface of the cladding part. The damping element is arranged around the membrane and is formed of one material.

The object of the present invention is to provide an assembly and a device by means of which an improved attenuation of oscillations can be achieved over a large temperature range.

This object is achieved by an assembly and a device according to the independent claims.

One aspect of the invention relates to an assembly for a motor vehicle with an ultrasonic sensor. The ultrasonic sensor is designed for concealed installation at a cladding part of the motor vehicle. The ultrasonic sensor comprises a membrane capable of oscillation for transmitting and/or receiving ultrasonic signals. Ultrasonic signals can be transmitted to the cladding part by means of the membrane. The assembly comprises a damping element that is arranged surrounding a longitudinal axis of the membrane and around the ultrasonic sensor, wherein at least the membrane extends through a cutout of the damping element, wherein oscillations of the cladding part can be attenuated by means of the damping element when in the installed state.

The damping element comprises reinforcing elements. In the case for example of a temperature rise in the material of the damping element, and a consequent reduction in the stiffness of the material, deeper-lying regions of the damping element can thereby also be excited. The stiffer are the reinforcing elements, the earlier the oscillation energy can be introduced into the whole of the damping element. In particular, the dead-time of the ultrasonic sensor can thereby be reduced and at the same time an improved attenuation of oscillations can be achieved over a large temperature range.

In particular, the damping element comprises a basis material and the reinforcing elements are formed of a material that is different from the basis material. The reinforcing elements are in particular contained in the basis material. It is furthermore in particular provided that unwanted oscillations of the cladding part can be attenuated in the installed state. In other words, by means of the ultrasonic sensor, the ultrasonic signals that are transmitted from the ultrasonic sensor are thereby transmitted efficiently through the cladding part to the air, while the unwanted oscillations of the cladding part, in particular following the transmitting process of the ultrasonic sensor, are better damped. The settling time of the cladding part, and thereby of the ultrasonic sensor, in particular the membrane, can thereby be reduced, so that the dead time of the ultrasonic sensor can also be reduced. The dead time of the ultrasonic sensor refers in particular to the time that is required, following the transmitting process, for the ultrasonic sensor to be ready to receive.

Preferably the ultrasonic sensor comprises a coupling element that is separate from the damping element, by means of which the ultrasonic signals can be better transferred from the membrane to the cladding part. The coupling element is in particular arranged between the membrane and the cladding part. The coupling element and the damping element are different components of the assembly, and differ from one another in particular both in their installation position within the assembly as well as in the way that they function. The damping element is in particular arranged overlapping the membrane axially. It can be provided that the damping element is arranged encompassing the membrane at the outer perimeter of the membrane at a predefined distance around the longitudinal axis. The coupling element is designed in the form of a plate or disc, and is in particular arranged at the membrane at its face. The coupling element in particular does not comprise a cutout, and does not overlap the membrane axially.

According to one advantageous form of embodiment, the reinforcing elements can be distributed homogeneously in the damping element. The oscillation energy can thereby be introduced better into the whole damping element, and the deeper-lying regions of the damping element can also be reached better, so that an improved attenuation of the oscillations can be achieved.

It has furthermore been found advantageous if the damping element comprises hollow spheres as reinforcing elements. The hollow spheres exhibit a higher stiffness than the damping element, and can thus absorb the oscillations better. It is thereby in particular possible that the ultrasonic sensor can be used over a large temperature range, since the oscillation energy, in particular the unwanted oscillations, can be passed on better to the hollow spheres, and the damping element can thus dampen these oscillations better.

It is also advantageous if the damping element comprises fibres as reinforcing elements. In particular, the oscillation energy can be distributed better in the whole damping element through the introduction of fibres. The deeper-lying regions of the damping element can thereby also be reached by means of the transfer of the oscillation energy to the fibres. The process of introducing fibres into the damping element is, furthermore, very simple, since the fibres can be taken into consideration during the manufacture of the damping element.

It has further been found advantageous if the damping element comprises glass fibres and/or ceramic fibres and/or basalt fibres and/or mineral fibres and/or stainless steel fibres and/or aluminium fibres and/or plastic fibres as reinforcing elements. The above-mentioned fibres exhibit in particular a high modulus of elasticity over a wide temperature range, which means that these materials exhibit a high stiffness. The oscillation energy can thereby be better guided even into the deeper-lying regions of the damping element, and an improved attenuation of the oscillations thereby realized over a large temperature range.

It is also advantageous if the reinforcing elements exhibit a coefficient of elasticity greater than 1000 N/mm². The reinforcing elements thereby exhibit a higher stiffness than the damping material, whereby the oscillations can be attenuated better.

According to a further advantageous form of embodiment, the basis material of the damping element can be formed of butyl rubber. Butyl rubber has in particular a very high damping effect in the ultrasonic range over a wide temperature range. As a result of the form of embodiment of the damping elements of butyl rubber, an improved attenuation of the oscillations thus can already be achieved over a high temperature range.

It has furthermore been found to be advantageous if the damping element with the reinforcing elements provides an attenuation at least of −250 dB, in particular for structure-borne sound waves in the ultrasonic frequency range over a temperature range from −30° C. to +90° C. Since the ultrasonic sensor is in particular designed for motor vehicles, and motor vehicles in particular are subject to this temperature range, it is advantageous if the damping element and the reinforcing elements exhibit a high attenuation in this temperature range. In particular, the attenuation in the present case is at least −250 dB, so that the oscillations, in particular the unwanted oscillations, of the cladding part can be better reduced. The ultrasonic sensor can thereby be better operated over the temperature range from −30° C. to +90° C., so that an improved resolution of the ultrasonic signals of the ultrasonic sensor can be achieved with a lower dead time of the ultrasonic sensor.

According to a further advantageous exemplary embodiment, at least the shape of the reinforcing elements and/or the position of the reinforcing elements in the damping element are matched to a resonant frequency of the ultrasonic sensor. The shape of the reinforcing elements and/or the position of the reinforcing elements, as well as the number of the reinforcing elements, in the damping element are in particular designed in such a way that a maximum attenuation occurs at the resonant frequency of the ultrasonic sensor. Since the ultrasonic sensor in particular, and in particular the transmitted ultrasonic signals, and the cladding part are matched to the resonant frequency, it is in particular advantageous if the shape of the reinforcing elements and/or the position of the reinforcing elements in the damping element are also matched to the resonant frequency. In the resonant frequency range in particular, an improved attenuation of those oscillations that are unwanted can thereby be achieved, so that these oscillations can be attenuated over a predetermined temperature range.

It is furthermore advantageous if the cutout of the damping element is annular in shape. The damping element can thereby in particular be arranged around the membrane, whereby the unwanted oscillations can be attenuated better with respect to the membrane, so that the dead time of the membrane after the transmitting process until the receiving process, and after the receiving process until the transmitting process, can be attenuated better. The unwanted oscillations can thereby be attenuated for the membrane in particular.

It has furthermore been found to be advantageous if the ultrasonic sensor comprises at least one holding element with which the ultrasonic sensor can be installed at the cladding part in a concealed manner. The ultrasonic sensor can thereby be arranged at the cladding part and decoupled from oscillations of the cladding part. The unwanted oscillations are thus transferred from the cladding part to the damping element, whereby the ultrasonic sensor, in particular the membrane, is decoupled from these oscillations, whereby an improved operation can be realized.

A further aspect of the invention relates to a device for a motor vehicle. The device comprises an assembly in accordance with one of the preceding aspects and a cladding part for a motor vehicle and at least one ultrasonic sensor. The ultrasonic sensor is arranged in a concealed manner at the cladding part, so that the ultrasonic sensor is arranged for the transmission of ultrasonic signals through the cladding part and/or for the reception of echo signals through the cladding part.

Yet another further aspect of the invention relates to a motor vehicle with a device. The motor vehicle is embodied in particular as a passenger motor vehicle.

Advantageous forms of embodiment of the assembly are to be seen as advantageous forms of embodiment of the device as well as of the motor vehicle.

Further features of the invention emerge from the claims, the figures and the description of the figures. The features and combinations of features that are cited in the description above, and also the features and combinations of features that are cited in the description of the figures below and/or as shown in the figures alone, can be used not only in the respectively indicated combination but also in other combinations or on their own without departing from the scope of the invention. Embodiments of the invention that are not explicitly shown and explained in the figures, but emerge and are producible from the explained embodiments by virtue of self-contained combinations of features, are therefore also intended to be regarded as included and as disclosed. Embodiments and combinations of features that therefore do not have all the features of an independent claim as originally worded are also intended to be regarded as disclosed. Embodiments and combinations of features that go beyond or differ from the combinations of features set out in the back-references of the claims, should furthermore be considered to be disclosed, in particular by the embodiments set out above.

The invention will now be explained in more detail on the basis of preferred exemplary embodiments and with reference to the attached drawings.

In the figures:

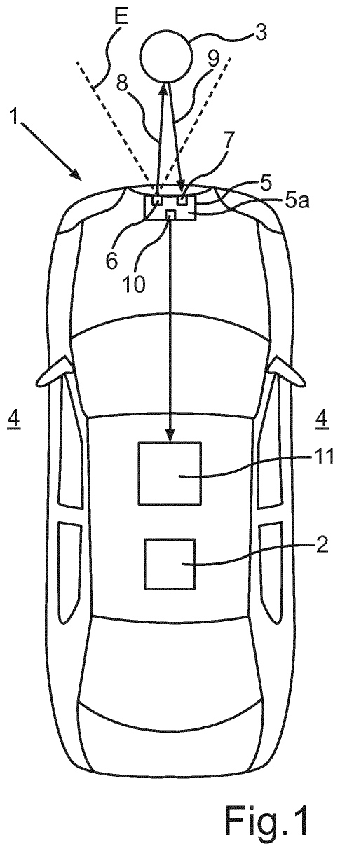

FIG. 1 shows a schematic plan view of a motor vehicle with one form of embodiment of an assembly;

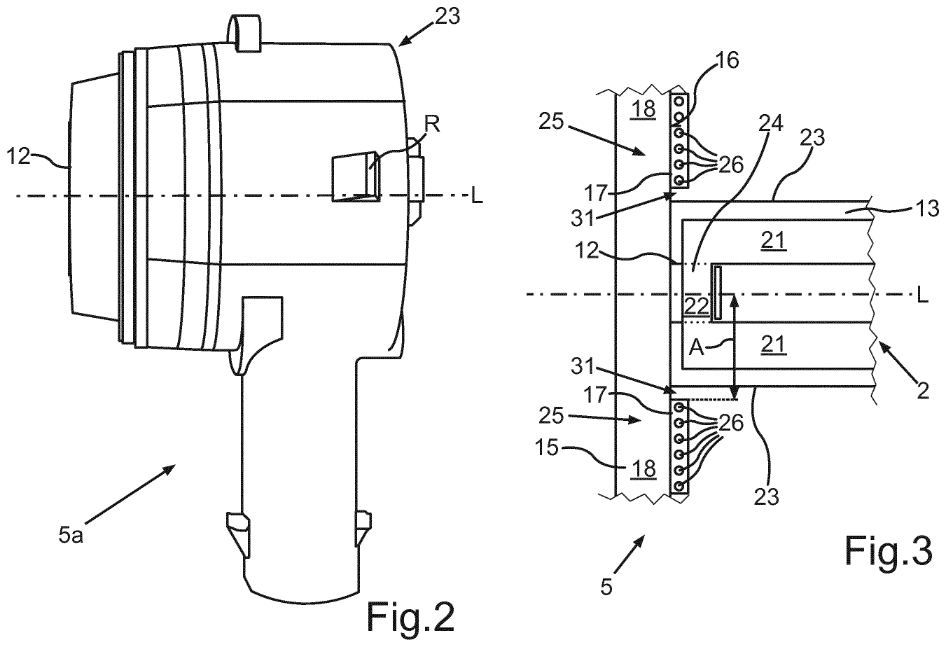

FIG. 2 shows a schematic side view of a form of embodiment of an ultrasonic sensor;

FIG. 3 shows a further schematic view of a form of embodiment of the assembly;

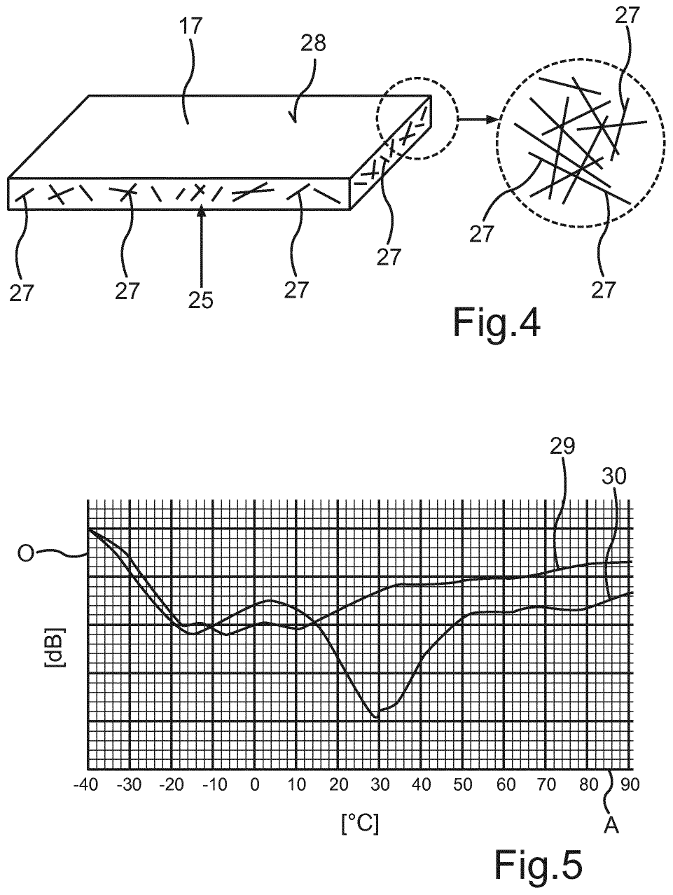

FIG. 4 shows a schematic perspective view of a form of embodiment of a damping element; and

FIG. 5 shows a temperature-attenuation diagram of one form of embodiment of the ultrasonic sensor.

The same reference signs are given in the figures to identify elements that are identical and have the same functions.

FIG. 1 shows a motor vehicle 1. The motor vehicle 1 is designed in the present exemplary embodiment as a passenger car. The motor vehicle 1 comprises a driver assistance system 2. An object 3 that is located in a surroundings 4 of the motor vehicle 1 can for example be acquired with the driver assistance system 2. A distance between the motor vehicle 1 and the object 3 can in particular be determined by means of the driver assistance system 2.

The driver assistance system 2 comprises at least one assembly 5. The assembly 5 in turn comprises at least one ultrasonic sensor 5a. The assembly 5 can also comprise further ultrasonic sensors 5a. The ultrasonic sensor 5a comprises a transmitting device 6 by means of which at least one ultrasonic signal 8, in particular a plurality of ultrasonic signals 8, can be transmitted. The assembly 5 is arranged in the present case at a front region of the motor vehicle 1. The assembly 5 can also be arranged in other regions, for example at a rear region or a side region of the motor vehicle 1. The following example is thus not to be considered as conclusive, but serves purely for illustration.

The ultrasonic signals 8 can be transmitted with the transmitting device 6 within a predetermined acquisition range E, or a predetermined angular range, by means of a membrane 13 (FIG. 3).

The assembly 5 furthermore comprises a receiving device 7 by means of which reflected ultrasonic signals can be received as echo signals 9 that were reflected from the object 3, in particular via the membrane 13. Echo signals 9 reflected from the object 3 can thus be received with the receiving device 7 as received signals. The assembly 5 can furthermore comprise a control device 10 that can for example be formed by a microcontroller and/or a digital signal processor. The driver assistance system 2 further comprises a control device 11 that can for example be formed by an electronic control unit (ECU) of the motor vehicle 1. The control device 11 is connected to the assembly 5 for data transfer. The data transfer can for example take place via the data bus of the motor vehicle 1.

FIG. 2 shows a side view of the ultrasonic sensor 5a, which is suitable for concealed installation at a cladding part 15 (FIG. 3). The ultrasonic sensor 5a comprises a coupling element 12 that lies against the cladding part 15, by means of which ultrasonic signals 8 can be transmitted and/or received by the membrane 13 of the ultrasonic sensor 5a. Ultrasonic signals 8 can be transferred to the cladding part 15 by means of the membrane 13 and of the coupling element 12. The coupling element 12 is here formed in particular in the direction surrounding a longitudinal axis L of the membrane 13. Latching elements R are further shown in FIG. 2, by means of which the ultrasonic sensor 5a can be held in particular at the cladding part 15. The latching elements R are in particular designed at an outer side 23 of the ultrasonic sensor 5a.

FIG. 3 shows a schematic side view of an example of an installed ultrasonic sensor 5a, at least in partial components. The ultrasonic sensor 5a is arranged at a rear side 16 of the cladding part 15. The cladding part 15 can in particular be designed as the bumper of the motor vehicle 1. A damping element 17, having in particular an annular form, is arranged next to the membrane 13 in a circular manner around the ultrasonic sensor 5a. The damping element 17 is in particular arranged at the rear side 16. The damping element 17 is in particular arranged surrounding the longitudinal axis L of the membrane 13 and around the ultrasonic sensor 5a. The membrane 13 extends through a cutout 31 of the damping element 17. The cutout 31 can here in particular be annular in form. A transfer of energy, in particular sound energy, of the ultrasonic sensor 5a can thereby be attenuated in other regions of the cladding part 15. By means of the damping element 17, furthermore, oscillations from the cladding part 15 to the ultrasonic sensor 5a can be attenuated.

The coupling element 12 is in particular arranged between the membrane 13 and the cladding part 15. The coupling element 12 and the damping element 17 are different components of the assembly 5, and differ from one another in particular both in their installation position within the assembly 5 as well as in the way that they function. The damping element 17 is in particular arranged overlapping the membrane 13 axially. It can be provided that the damping element 17 is arranged encompassing the membrane 13 at the outer perimeter of the membrane 13 at a predefined distance A around the longitudinal axis L. The coupling element 12 is in particular designed in the form of a plate or disc, and is in particular arranged at the membrane 13 at its face. The coupling element 12 in particular does not comprise a cutout 31, and does not overlap the membrane 13 axially.

The ultrasonic sensor 5a is structurally joined to the cladding part 15 in particular by way of at least one holding element. The holding elements can for example be joined to the latching elements R. It is furthermore possible that the holding elements have further damping elements at the end at which they are joined to the ultrasonic sensor 5a. The further damping elements can in particular be provided so that oscillations of the ultrasonic sensor 5a are transmitted to the cladding part 15 to a reduced extent, or that oscillations of the cladding part 15 are prevented at the ultrasonic sensor 5a. It can furthermore in particular be provided that the ultrasonic sensor 5a comprises a thick-walled region 21 and a thin-walled region 22.

In the thin-walled region 22 the membrane 13 can in particular comprise a piezo element 24 that can be electrically driven, and the membrane 13 can be made to oscillate through the electric drive of the piezo element 24. The ultrasonic signals 8 can in particular be generated thereby. The echo signals 9 can, furthermore, be received via the membrane 13 and the piezo element 24 and converted into electric signals.

It is provided that the damping element 17 comprises reinforcing elements 25. In particular, the damping element 17 is made of a basis material and the reinforcing elements 25 are formed of a material that is different from the basis material. The reinforcing elements 25 are here in particular contained in the basis material. The basis material of the damping element 17 can be formed for example of butyl rubber. The reinforcing elements 25 can in particular exhibit a coefficient of elasticity greater than 1000 N/mm². The reinforcing elements 25 in the following form of embodiment are designed as hollow spheres 26. By means of this form of embodiment it is possible that the oscillation energy of the cladding part 15, in particular after the transmitting process, can be better attenuated, since the reinforcing elements 25 raise the stiffness of the damping element 17 and thus guide the oscillations of the cladding part 15 into deeper regions of the damping element 17, whereby an improved attenuation, in particular over a large temperature range, is made possible. The dead time of the ultrasonic sensor 5a can thereby be reduced, so that an improved operation of the ultrasonic sensor 5a is enabled over a large temperature range.

A device preferably comprises the assembly 5. The device is in particular formed with the cladding part 15 for the motor vehicle 1, wherein the ultrasonic sensor 5a is arranged in a concealed manner at the cladding part 15, so that the ultrasonic sensor 5a is arranged for the transmission of ultrasonic signals 8 through the cladding part 15 and/or for the reception of echo signals 9 through the cladding part 15.

FIG. 4 shows a schematic perspective view of a form of embodiment of the damping element 17. The reinforcing elements 25 in the present form of embodiment are distributed, in particular homogeneously, in the damping element 17. In the present exemplary form of embodiment, the damping element 17 comprises fibres 27 as reinforcing elements 25. The damping element 17 can for example comprise glass fibres and/or ceramic fibres and/or basalt fibres and/or mineral fibres and/or stainless steel fibres and/or aluminium fibres and/or plastic fibres as fibres 27 as reinforcing elements 25. The damping element 17 in the present case comprises in particular a covering layer 28 by means of which the damping element 17 can be better protected, in particular from environmental influences.

In particular it is provided that at least the shape of the reinforcing elements 25 and/or the position of the reinforcing elements 25 in the damping element 17 are matched to a resonant frequency of the ultrasonic sensor 5a. In particular, the damping element 17 and the reinforcing elements 25 are so designed that a maximum attenuation occurs at the resonant frequency of the ultrasonic sensor 5a.

FIG. 5 shows a temperature-attenuation diagram of an exemplary form of embodiment of the damping element 17. The temperature, in particular the ambient temperature, is given in ° C. on the abscissa A, and the attenuation is given in db on the ordinate O. The line 29 here in particular shows the attenuation curve of a damping element without reinforcing elements 25. The line 30 shows the attenuation curve over the temperature range of the damping element 17 with the reinforcing elements 25. The diagram shown in FIG. 5 is purely exemplary, and not to be thought of as conclusive. It serves merely to illustrate the idea according to the invention. It is in particular to be seen in the following diagram that the line 30, which describes the damping element 17 with the reinforcing elements 25, exhibits a very high attenuation, in particular in the range between +15° C. and +50° C. An improved attenuation is to be seen, in particular in comparison with the line 29. As FIG. 5 shows, an improved attenuation of the cladding part 15 is to be observed here, in particular at the ambient temperatures from +15° C. to +50° C. The attenuation depends in particular on the reinforcing elements 25, so that it is also possible that an altogether better attenuation of the damping element 17 with the reinforcing elements 25 is to be observed in comparison with simply a damping element without reinforcing elements 25 in a temperature range from −30° C. up to +90° C.

It is in particular provided that the damping element 17 and the reinforcing elements 25 exhibit an attenuation of −250 db over a temperature range from −30° C. up to +90° C.

1. An assembly for a motor vehicle comprising:
an ultrasonic sensor for concealed installation at a cladding part of the motor vehicle;
a membrane capable of oscillation for transmitting and/or receiving ultrasonic signals,
wherein ultrasonic signals are transferred by the membrane to the cladding part; and
a damping element that is arranged surrounding a longitudinal axis of the membrane and around the ultrasonic sensor,
wherein at least the membrane extends through a cutout of the damping element,
wherein oscillations of the cladding part are attenuated by the damping element when in the installed state, wherein the damping element comprises reinforcing elements.

2. The assembly according to claim 1, wherein the reinforcing elements are distributed homogeneously in the damping element.

3. The assembly according to claim 1, characterized in that the damping element comprises hollow spheres as reinforcing elements.

4. The assembly according to claim 1, wherein the damping element comprises fibres as reinforcing elements.

5. The assembly according to claim 4, wherein the damping element comprises glass fibres and/or ceramic fibres and/or basalt fibres and/or mineral fibres and/or stainless steel fibres and/or aluminium fibres and/or plastic fibres as reinforcing elements.

6. The assembly according to claim 1, wherein the reinforcing elements exhibit a coefficient of elasticity greater than 1000 N/mm².

7. The assembly according to claim 1, wherein the damping element comprises a covering layer (28).

8. The assembly according to claim 1, wherein a basis material of the damping element is formed of butyl rubber.

9. The assembly according to claim 1, wherein the damping element and the reinforcing elements exhibit an attenuation of at least −250 db over a temperature range from −30° C. up to +90° C.

10. The assembly according to claim 1, wherein at least the shape and/or the position of the reinforcing elements in the damping element are matched to the resonant frequency of the ultrasonic sensor.

11. The assembly according to claim 1, wherein the cutout of the damping element is of annular design.

12. The assembly according to claim 1, further comprising at least one holding element by which the ultrasonic sensor is installed at the cladding part in a concealed manner.

13. A device comprising:
an assembly according to claim 1; and
a cladding part for a motor vehicle,
wherein the ultrasonic sensor is arranged in a concealed manner at the cladding part, so that the ultrasonic sensor is arranged for the transmission of ultrasonic signals through the cladding part and/or for the reception of echo signals through the cladding part.
